(19) United States
(12) Patent Application Publication
(10) Pub. No.: US 2014/0261645 A1
(43) Pub. Date: Sep. 18, 2014

(54) SEMICONDUCTOR-CONDUCTOR COMPOSITE PARTICLE STRUCTURES FOR SOLAR ENERGY CONVERSION

(71) Applicant: RESEARCH TRIANGLE INSTITUTE, Research Triangle Park, NC (US)

(72) Inventor: Paul Gerard Hoertz, Morrisville, NC (US)

(73) Assignee: RESEARCH TRIANGLE INSTITUTE, Research Triangle Park, NC (US)

(21) Appl. No.: 14/211,609

(22) Filed: Mar. 14, 2014

Related U.S. Application Data
(60) Provisional application No. 61/794,508, filed on Mar. 15, 2013.

(51) Int. Cl. H01G 9/20

(52) U.S. Cl. CPC H01G 9/2027
USPC 136/254; 204/290.01

(57) ABSTRACT

An electrode for solar conversion including a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor. The porous structure has a set of electrically conductive nanoparticles adjoining each other. The set of electrically conductive nanoparticles forms a meandering electrical path connecting the nanoparticles together. The porous structure has a semiconductive coating disposed conformally on the electrically conductive nanoparticles to form an exterior surface for reception of charge carriers.

### CROSS REFERENCE TO RELATED APPLICATIONS

This application claims priority to U.S. provisional application No. 61/794,508 filed on Mar. 15, 2013, the entire contents of which are incorporated herein by reference. U.S. provisional application No. 61/794,508 is related to provisional U.S. Ser. No. 61/794,959 entitled “ADVANCED SEMICONDUCTOR-CONDUCTOR COMPOSITE PARTICLE STRUCTURES FOR SOLAR ENERGY CONVERSION” filed Mar. 15, 2013, Attorney Docket No. 412865US-2025-2025-20, the entire contents of which are incorporated herein by reference.

### BACKGROUND OF THE INVENTION

1. Field of the Invention

The present invention is related to nanoparticles, nanoparticle structures, methods and devices for energy conversion.

2. Description of the Related Art

Solar energy, a clean and abundant energy source, is the ultimate solution to escalating global energy demands. Of all the carbon-neutral alternative energies, solar energy is arguably the only source that can meet and surpass the predicted additional 30 terrawatts that will be consumed by humans by the year 2050 while combating the ill effects of global warming. In one hour, the Earth receives more than enough energy from the Sun to supply humanity's annual needs. The issue then becomes: How do we as humans harness this seemingly endless energy supply in an economical and practical fashion?

Solar energy conversion can be broken down into two subsets: solar photonic and solar thermal. In solar thermal systems, sunlight is concentrated to build up enough heat to carry out chemical transformations or to vaporize fluids to turn turbines for electricity generation. These systems, for example, consist of fields of either large mirrors that reflect incident light onto a collector tower or a multitude of parabolic mirrors having tubes containing fluid at their focal point. These “solar farms” are currently built in regions that receive large amounts of solar irradiation, e.g. the Southwest U.S. In order for solar thermal to become a viable option, significant advances in the electrical grid must be made in order to minimize the power that is lost as the electricity is transferred over large distances.

Solar photonic devices, on the other hand, are more practical for on-site energy generation. Existing solar photonic energy conversion technologies almost exclusively rely on the direct conversion of sunlight to electricity with photovoltaic devices. In the fifty years since their arrival to the marketplace, there still exists an unfortunate tradeoff: high efficiency solar cells (e.g. Si, GaAs) are also the most costly.

The high cost stems from the need for high purity semiconductors and materials that minimize the recombination of free carriers (holes and electrons) that are created upon light absorption; higher defect densities result in lower charge separation yields due to recombination. A simple yet practical concern with all solar energy strategies is the fact that energy generation will fall to zero once the sun sets at night. Hence, in order for solar energy to take on a lion's share of the energy market in the future, humanity must develop reliable methods for storing solar energy so that it can be used hours later at night.

One way to overcome this issue is to convert the energy from the sun into chemical energy through the production of high energy solar fuels (e.g. hydrogen). In solar fuel production, the energy from the sun is utilized to drive endothermic, small molecule reactions. Two approaches are water splitting (i.e. photoconversion of renewable, abundant water into hydrogen and oxygen) and water reduction of carbon dioxide into methanol, methane, or hydrocarbons. Both processes are carbon-neutral and would alleviate global warming if applied at the global scale.

The energy stored in solar fuels can be harnessed either with electricity-generating fuel cells or through their combustion. Solar fuels bridge the gap between solar thermal and solar photonic technologies. Solar fuels can be formed and stock-piled at “solar farms” and then transported for use at power plants adjacent to communities. Alternately, solar fuels can be produced on-site for on-demand use or be stored for power generation at nighttime. Still another advantage of solar fuels is that they potentially can be used as transportation fuels in automobiles. Solar fuels are therefore a practical solution to the energy storage problem that plagues solar energy conversion.

Accordingly, there exists a critical need to have a solution or solutions addressing the short-comings of existing solar fuel technologies such as photoelectrochemical cells and electrolysis driven by low-cost photovoltaics.

### SUMMARY OF THE INVENTION

In one embodiment of the present invention, there is provided an electrode for solar conversion including a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor. The porous structure has a set of electrically conductive nanoparticles adjoining each other. The set of electrically conductive nanoparticles forms a meandering electrical path connecting the nanoparticles together. The porous structure has a semiconductive coating disposed conformally on the electrically conductive nanoparticles to form an exterior surface for reception of charge carriers.

In one embodiment of the present invention, there is provided a solar conversion device including at least an anode and cathode made with the above-described electrode. The device includes a feedstock supply configured to supply feedstock into a region between the anode and cathode. The anode is configured to oxidize the feedstock. The cathode is configured to reduce constituents of the feedstock into a combustible fuel.

It is to be understood that both the foregoing general description of the invention and the following detailed description are exemplary, but are not restrictive of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A more complete appreciation of the invention and many of the attendant advantages thereof will be readily obtained as the same becomes better understood by reference to the following detailed description when considered in connection with the accompanying drawings, wherein:

FIG. 1A is a schematic of a PV-water electrolyzer device;

FIG. 1B s a schematic of a single absorber photoelectrochemical cell;

FIG. 1C is a schematic of a tandem photoelectrochemical solar fuel cell including separated p-type and n-type photoelectrodes;

FIG. 2A is a schematic of a nano-TiO₂ dye-sensitized solar cell (DSSC);

FIG. 2B is a schematic of a nano-TiO₂-based solar fuel device;

FIG. 2C is a field-emission scanning electron micrograph of TiO₂/ITO nanocomposite structure according to one embodiment of the invention;

FIG. 2D is a field-emission scanning electron micrograph of an uncoated ITO nanoparticle film;

FIG. 2E is a field-emission scanning electron micrograph of TiO₂/ITO nanocomposite structure according to one embodiment of the invention;

FIG. 2F is a field-emission scanning electron micrograph of Nb₂O₅/ITO nanocomposite structure according to one embodiment of the invention;

FIG. 3A is a fabrication process schematic showing the preparation of hybrid semiconductor-conductor porous nanoparticle structures according to one embodiment of this invention;

FIG. 3B is a fabrication process schematic showing preparation of hybrid semiconductor-conductor nanorod array electrodes according to one embodiment of this invention;

FIG. 4 is a plot of the cyclic voltammetry results for TiO₂/ITO nanocomposite structure prepared according to one embodiment of the invention and derivatized with a redox-active ruthenium compound;

FIG. 5A is a table comparing incident photon-to-current efficiency (IPCE) and absorbed photon-to-current efficiency (APCE) data for dye-sensitized solar cells constructed using TiO₂/ITO nanocomposite structures of this invention;

FIG. 5B incident photon-to-current efficiency data for dye-sensitized solar cells constructed using a TiO₂/ITO nanocomposite structures and a Nb₂O₅/ITO nanocomposite structures of this invention;

FIG. 6 is a schematic of an organic photovoltaic device incorporating nanocomposite semiconductor/conductor nanoparticle structures of this invention;

FIG. 7 is a micrograph of a transmission electron microscopy image of the 40 nm ITO nanoparticles after thin film annealing; AND

FIG. 8 is a schematic of a photocathode having a conducting nanostructure coated with a p-type semiconductor.

### DETAILED DESCRIPTION OF THE INVENTION

The invention in one aspect provides conformal nanoscale coatings onto pre-assembled, three dimensional objects for the creation of multi-component composites. In one example, a semiconductor coated consolidated conducting nanoparticle structure provides a unique structure for electron transport and utilization where electrons generated in the semiconductive material from the optical absorption of energy and the generation of electron-hole pairs merely have to be transported across nanometers of material before being in a conductive (metallic-like) medium. The semiconductive coating on the conducting shell forms a core-shell structure. The consolidated conducting nanoparticle structure forms the basis of a porous structure having the semiconductive coating deposited thereon.

In general, this core-shell structure 1) promotes the transfer of electrons from the shell to the conductive core, 2) serves as a physical barrier, and 3) controls the distance between charge carriers within conductive core and minority carriers located on the surface of the porous structure or within the porous structure, thereby controlling the kinetics of recombination. The higher charge carrier mobility of the conductive core and the core-shell structure favors transport and collection of electrons further impeding charge recombination.

This invention thus provides a novel approach where materials for solar conversion are provided in a configuration in which absorption of solar energy generates electron-hole pairs and efficiently separates the electrons from the holes. In solar fuel-generating devices, this configuration results in the efficient utilization of the holes for oxidation reactions and efficient utilization of the electrons for reduction reactions. In solar cell devices, this configuration results in efficient establishment of a photovoltaic voltage and current source without the high cost and complexities associated with single crystal or polycrystalline solar cells. These gains in efficiency are particularly relevant for photocathodes based on porous structures.

Accordingly, in one aspect of the present invention, there is provided a novel electron transport medium (ETM) for solar fuel photoelectrochemical devices based on composite nanoparticle thin films. The novel nanoparticle thin films form high surface area support structures that can be employed as the ETM in photoanodes of working photoelectrochemical solar fuel devices. In one embodiment of this invention, the ETMs can serve as porous, high surface area support structure onto which the light-harvesting and catalytic entities can be deposited. In one embodiment, the porous structure has a porosity ranging from 50 to 90%. In another embodiment, the porous structure has a porosity ranging from 60 to 80%. In another embodiment, the porous structure has a porosity ranging from 60 to 70%.

Accordingly, in one aspect of the present invention, there is provided a novel hole transport medium (HTM) for solar fuel photoelectrochemical devices based on composite nanoparticle thin films. The novel nanoparticle thin films form high surface area support structures that can be employed as the HTM in photocathodes of working photoelectrochemical solar fuel devices. In one embodiment of this invention, the HTMs can serve as porous, high surface area supports onto which the light-harvesting and catalytic entities can be deposited.

As noted above, the creation of conformal semiconductor-continuous conductor core-shell nanostructures means that electrons only have to be transported over nanoscale lengths from the site of light absorption before reaching the conductor (L ˜1-100 nm). In prior semiconducting nanoparticle thin film structures, the electron is transported along a longitudinal-direction through a series of semiconducting nanoparticles prior to reaching a planar transparent conducting oxide (TCO) electrode (average electron transport length ˜5-10 microns).

As noted above, in one embodiment of the invention, there is provided an electrode for solar conversion including a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor. The porous structure has a set of electrically conductive nanoparticles adjoining each other. The set of electrically conductive nanoparticles forms a meandering electrical path connecting the nanoparticles together. The porous structure has a semiconductive coating disposed conformally on the electrically conductive nanoparticles to form an exterior surface for reception of charge carriers.

As used herein, “meandering electrical path” means a conducting path from one nanoparticle to another and then to adjacent nanoparticles, etc. The meandering path is not a straight line path across the entirety of the porous structure. The meandering path in one embodiment can constitute a set of random diverging pathways across the entirety of the porous structure. The meandering path in one embodiment can be a more ordered approach where the nanoparticles are or are approximately in an ordered packing arrangement and the meandering path connects from one nanoparticle to another within this ordered packing arrangement.

As used herein, “optically transparent” is defined as at least about 50% of visible light transmittance there through. In some embodiments, the optically transparent is at least about 70% of visible light transmittance there through.

As used herein, “electrode” or “conductive structure” refers to an electrical conductor used to make contact with a nonmetallic part of a circuit (e.g. a semiconductor, an electrolyte or a vacuum).

As used herein, “semiconductive” refers to the electrical property of materials such as Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh) and other delafossite structured materials, and perovskites of the form ABX₃. Charge transport in these materials is by electrons and/or holes. Various organic semiconductors include organic dyes, such as methylene blue and the phthalocyanines; aromatic compounds, such as naphthalene, anthracene, and violanthrene; polymers with conjugated bonds; some natural pigments, such as chlorophyll and β-carotene; charge-transfer molecular complexes; and ion-radical salts.

In some embodiments, the average diameter of nanoparticles is less than about 1000 nm. In other embodiments, the average diameter of the nanoparticles is less than about 500 nm. In other embodiments, the average diameter of the nanoparticles is less than about 100 nm. In other embodiments, the average diameter of the nanoparticles is less than about 50 nm.

To understand the significance of this approach, at present, there are three practical ways to make solar fuels:
1) PV-water electrolyzer: A series of photovoltaic devices harness sunlight and produce the photovoltage necessary to carry out the reduction-oxidation (redox) reactions at two separate electrodes (FIG. 1A);
2) Photoelectrochemical cells: These devices carry out all of the necessary functions for producing solar fuels (i.e. light absorption, charge separation, electron collection, and catalytic redox reactions at two separate electrodes that are attached with a wire (FIG. 1B);
3) Photocatalysis: These systems carry out the necessary functions within the same “electrode” (e.g. n-type semiconducting TiO₂ nanoparticles that transport electrons between light absorber/oxidation catalyst conjugates and nanoparticles for catalytic reduction).

One issue with the first approach (using PV-water electrolyzers) is that these electrolyzers require stacking three or more photovoltaic solar cells in series in order to satisfy the high over-potentials that are needed. Hence, the cost of the overall device is highly dependent on the cost of the photovoltaic solar cell units.

One issue with the second and third approaches is that photocatalysis has historically yielded very low (<1%) quantum yields for solar fuel generation, presumably due to the fact that the redox reactions are not compartmentalized. As a result, electron-hole recombination occurs quite readily prior to catalysis. A particular problem with one-electrode systems is the possibility that the generated fuels can recombine catalytically prior to leaving the system (e.g. H₂ and O₂ recombining for example at Pt nanoparticles).

As with natural photosynthesis, the physical separation of pertinent reduction-oxidation (redox) processes appears to be an important criterion. In the photoelectrochemical method shown in FIG. 1B, two separate electrodes are connected with a wire. In order for a two-electrode system to work efficiently, one electrode has to absorb the incident light, and the absorption of the electrode (or the material of or on the electrode) should have a significant overlap with the solar spectrum. For both semiconductor and DS-PEC approaches, high efficiencies are possible with tandem cells. Water splitting and CO₂ splitting are thermodynamically and kinetically demanding; as a result, large overpotentials are required to achieve reasonable photocurrent densities. In order to satisfy these demands while absorbing a significant fraction of the solar spectrum, two complementary light absorbers can be coupled in series, in a similar fashion to the Z-scheme utilized in natural photosynthesis. In the tandem cell approach, two photons are absorbed, one at the photoanode (for an oxygen evolution reaction OER) and the other at the photocathode (for a hydrogen evolution reaction HER and/or CO₂ reduction).

FIG. 1C is a schematic of a tandem photoelectrochemical solar fuel cell including separated p-type and n-type photoelectrodes. One electron-hole pair is sacrificed to produce a higher energy electron-hole pair, thereby providing enough potential to overcome the necessary thermodynamic requirements, electrode overpotentials, and parasitic resistances (e.g. solution, membrane, separator) within the device. In one embodiment of the invention, the two photoelectrodes could be adjoined in a monolithic structure. A single absorber system is not expected to provide the efficiencies and photocurrent densities of a tandem device.

Regardless, for a planar electrode to absorb enough sunlight to be practical, the absorbing material needs to be thick enough so that the spectral part of the solar energy capable of producing electron-hole pairs is absorbed in that material.

FIG. 2A is a schematic of a dye-sensitized solar PV cell (DSSC). As shown in FIG. 2A, the red box represents a visible-light absorbing chromophoric dye molecule or sensitizer; D represents a solution-phase electron donor; and D+ represents an oxidized solution-phase electron donor.

This nanocrystalline approach of the invention avoids the cost of high-purity materials. Nanocrystalline films typically utilize a matrix of interconnected nanoparticles (e.g., 10-20 nm) which provides for very high overall surface areas (e.g., >100 m²/g). Since the overall surface area is high, the amount of absorbing material (e.g. organic or organometallic dye molecules, or sensitizers, that absorb visible-near IR, or quantum dots) that can be deposited is impressive (˜10⁻⁷ mol/cm²). Furthermore, nanocrystalline films containing a monolayer of dye molecules with reasonable extinction coefficients (10000-1000001M⁻¹cm⁻¹) can absorb essentially all visible-near IR incident photons.

NanoTiO₂ DSSCs allow for near unity incident-photon-to-current efficiencies (IPCEs); nearly all of the incident photons are absorbed by the ˜10 μm-thick nanoTiO₂ film and converted into electrons in the external circuit. The global efficiencies for these devices have reached an impressive 10-13%, limited mainly by their inability to harvest wavelengths longer than 800 nm.

FIG. 2B is a schematic of a nano-TiO₂-based solar fuel device. As shown in FIG. 2B, the red box represents a chromophore (e.g., a Ru bipyridyl complex or a Ru terpyridine complex), and the blue box represents a catalyst (e.g., Co₃O₄, IrO₂, molecular catalyst). The critical issue is that the electron diffusion length for nanoTiO₂ is large (˜10 μm) and films of this thickness are needed to absorb >90% of the incident light. These electron diffusion lengths are nonetheless possible with DSSCs because a redox couple (e.g., a iodine redox electrolyte) is present within the mesopores of the nano-TiO₂ to intercept any oxidized sensitizer that is formed after light absorption by the chromophore and excited state electron transfer from the chromophore to the conduction band of TiO₂. The redox couple further separates electrons and holes, thereby slowing down charge recombination between electrons being transported through the nanoparticle film and the oxidized redox couple.

However, for solar fuel production, redox couples are not practical because their use would introduce significant losses in the photovoltage necessary for achieving water oxidation catalysis. Oxidizing equivalents need to be transferred to catalysts that are within 2-3 nm from the nanoparticle surface. Because electrons and holes cannot be separated over large distances, recombination effectively competes with electrons transport through the nanoTiO₂ matrix, hence the reported low (e.g., <1%) efficiencies for nanoTiO₂ matrix solar fuel devices.

Accordingly, in a conventional working photoelectrochemical solar fuel device, photochemical excitation of surface-bound chromophores produces excited states which inject electrons into the adjacent semiconductor coating (e.g., TiO₂), leaving behind the oxidized chromophore; i.e. holes. The holes are then transferred to nearby electrocatalysts that activate the four-electron oxidation of water to protons and oxygen. For the semiconductor-conductor composite ETM of this invention, the injected electrons are transported across the conformal semiconducting layer into the conductive electron transport medium (CETM).

According to one embodiment of this invention, the CETM is a continuous array of fused, low-impedance conductive nanoparticles (e.g., ITO nanoparticles) that directs the electrons to the underlying planar conductive substrate for extraction into an external circuit. The collected electrons are then used at the counterelectrode as reducing equivalents to reduce protons to hydrogen solar fuel.

In another embodiment, two photoelectrodes are used in a tandem cell. In the tandem cell approach for solar fuel production, two photons are absorbed, one at the photoanode (OER) and the other at the photocathode (HER and/or CO₂ reduction). One electron-hole pair is sacrificed to produce a higher energy electron-hole pair, thereby providing enough potential to overcome the necessary thermodynamic requirements, electrode overpotentials, and parasitic resistances (e.g. solution, membrane, separator) within the device. The photoelectrodes in this embodiment are separated by electrolyte containing the feedstocks for fuel production. A membrane or separator can also be inserted between the photoelectrodes to keep the fuels produced at the two electrodes separated. Light entry into the device can occur through one transparent photoelectrode. The tandem approach for photovoltaics is similar but with two photoelectrodes separated by a redox electrolyte or a electron/hole conducting solid-state medium.

By making the electron diffusion length vanishingly small and by controlling the thickness of the semiconductor shell (1-100 nm), parasitic electron-hole recombination rates are expected to plummet because of the following:
1) the CETM offers low impedance electron transport relative to all-semiconductor ETMs,
2) the semiconductor-conductor interface provides the potential for charge rectification (electron hole separation), and
3) the electron transfer rates decrease exponentially with distance (in this case, the distance should equal the thickness of the semiconducting layer).
4) the core-shell structure promotes the transfer of electrons from the shell to the conductive core due to the nanoscale thickness of the shell.
   The rectifying semiconductor-conductor interface of this nanostructure should reduce or prevent charge recombination and allow for the kinetically slow four-electron oxidation of water to proceed at electrocatalysts that are bound to a surface of the CETM.

Since the electron diffusion length no longer controls the thickness of the nanocrystalline film that can deliver electrons, unity incident light-harvesting efficiencies can be attained even with thicker nanoparticle films (>10 microns), in stark contrast to conventional approaches.

### Fabrication of Hybrid Semiconductor-Conductor Nanoparticle Electrodes

In one embodiment of the invention, the conductive material includes, but is not limited to, one of the following transparent conducting oxides (TCO): tin-doped indium oxide (ITO), antimony-doped tin oxide (ATO), fluorine-doped tin oxide (FTO), aluminum-doped zinc oxide (AZO), gallium-doped zinc oxide (GZO), and indium-doped zinc oxide (IZO).

In one embodiment of the invention, hybrid semiconductor-conductor nanoparticle electrodes are fabricated from colloidal suspensions of conductive nanoparticles (e.g. tin-doped ITO nanoparticles) which are deposited to form porous conductive films on planar TCO substrates, e.g., FTO or ITO. Films from the colloidal suspensions of conductive nanoparticles can be deposited via spin-coating or a doctor-blade method with tape-casting to set the thickness of a well between the tape. For spin-coating, the thickness of the film can be varied by controlling the concentration of nanoparticles in the suspension, the number of consecutive spins, and the spin rate. For the doctor-blade method, the thickness will be controlled by varying the number of tape layers on either side of the film.

The deposited films are then annealed to sinter the particles and minimize interparticle resistance. An important attribute of the resultant films is that electrical continuity exists throughout the entire thickness of the deposited nano-ITO film.

The following deposition methods can then be used to coat the conductive nanoparticles and thereby form the semiconductor-conductor hybrid nanoparticle films and the semiconductor-conductor hybrid nanoparticle structures of the invention
1) thermally-activated chemical bath deposition such as for example electrodeposition using metal-oxide precursors (e.g. using TiCl₃),
2) atomic layer-by-layer deposition,
3) polymer-assisted deposition,
4) surface sol-gel deposition
5) electrostatic layer-by-layer assembly,
6) plasma-enhanced CVD, and
7) a combination of two of more of the above.

FIG. 2C is a micrograph of TiO₂/ITO nanocomposite structure according to one embodiment of the invention made by consolidating a plurality of ITO nanoparticles and then depositing on the consolidated particles a semiconductor layer of TiO₂. The micrograph shows conformal deposition of the semiconductor layer onto the near surfaces of consolidated ITO nanoparticles.

By applying the coating to pre-deposited nanoparticle films (or nanostructures), continuity between the nanoparticles of the pre-deposited material is retained. Specific ones of the coating processes (and improvements thereof) are described in detail below. The invention is not restricted to the use of either the conventional techniques or the improved techniques or a combination thereof. Any of these techniques or others known in the art may be used in the various embodiments and application areas described below to produce the novel porous semiconductor/conductor structures of this invention. In one aspect of this invention, the semiconductor coating(s) can be those described in the related application noted above entitled “ADVANCED SEMICONDUCTOR-CONDUCTOR COMPOSITE PARTICLE STRUCTURES FOR SOLAR ENERGY CONVERSION” which is incorporated herein in its entirety by reference.

Polymer-Assisted Deposition

In polymer-assisted deposition (PAD), a soluble polymer is infiltrated with metal oxide precursor compounds. This is achieved either through favorable electrostatic interactions between the polymer and metal oxide precursor compound or through covalent attachment of the metal oxide compound directly to the polymer backbone (known in the art). The polymer-metal oxide precursor conjugate solution is then purified by ultrafiltration or dialysis and then utilized to deposit thin films. Conventionally, PAD has almost exclusively been applied to deposit thin films onto two-dimensional (2-D) substrates/surfaces. In one example, PAD was utilized to deposit nanoscale titania or zirconia coatings onto three-dimensional (3-D) porous aluminum oxide membranes.

In conventional PAD, the polymer-metal oxide precursor is deposited by spin-coating or through dip-coating. These techniques do not allow for tight control of the film thickness at the nanoscale (1-30 nm), especially for 3-D nanoparticle films. Furthermore, it is difficult to eliminate completely the formation of metal-based, intermolecular linkages between two or more polymer strands. As a result, more reactive metal oxide precursor compounds cannot be utilized since intermolecular linkages will become more prevalent, especially in aqueous environments.

Moreover, the choice of polymer and metal oxide precursor compound is extremely limited because of one the following: 1) precipitation of polymer-metal oxide precursor compound, 2) formation of metal oxide colloidal particles, and 3) formation of supramolecular oligomeric species through polymer-metal-polymer connections. Since intermolecular linkages cannot be well-controlled with PAD using existing technology, this becomes problematic when desiring to infiltrate porous nanoparticle films and structure with the polymer-metal oxide precursor conjugates. If supramolecular oligomeric species exist, these species may be too large to enter the porous nanoparticle film (average pore size <30 nm) or result in the blocking of pores. Further, co-deposition of oligomeric and unimolecular species may result in uneven metal oxide coatings on the underlying support. Finally, the best results to date for metal oxide coatings using conventional PAD were achieved with polyethylenimine with 50% of the amine groups functionalized with carboxylic acids (i.e. PEIC).

In one embodiment of this invention, polyacrylic acid (PAA) is used. The inventors found PAA to chemically adsorb to metal oxide surfaces in either aqueous or non-aqueous environments. Since PAA chemically adsorbs to the surface of the underlying support, monolayers of PAA can be deposited.

PAA deposition is performed by exposing the nanosupport (e.g. ITO nanoparticles deposited on planar ITO glass substrates, i.e. nanoITO/ITO/glass) to aqueous or methanolic solutions of PAA for a prescribed period of time followed by rinsing. The deposition time can be varied to control the extent of PAA deposition. In the next step, PAA/nanoITO/ITO/glass, for example, is exposed to a solution containing the metal oxide precursor compound for another prescribed period of time (e.g. titanium diisopropoxide bis(acetylacetonate) in 1:1 methanol/water or methanol) followed by a rinsing step. The deposition time can be varied to control the extent of reaction between surface-bound PAA molecules and the metal-oxide precursor compound.

With this process, more highly reactive metal oxide precursor compounds (e.g. titanium tetrabutoxide) can be utilized because the PAA molecules are already surface-bound, thereby eliminating the intermolecular linkage and oligomerization. As a result, this allows for a broader range of chemistries to be considered for creating the polymer-metal oxide precursor compound conjugates. In methanol solution, it has been experimentally verified that titanium diisopropoxide bis(acetylacetonate) and titanium tetrabutoxide rapidly form conjugates with PAA to form Ti-PAA. In aqueous environments, attempts to infiltrate PAA with titanium diisopropoxide bis(acetylacetonate) results in undesirable gel formation. The use of titanium tetrabutoxide is not conducive to aqueous environments, while the addition of titanium tetrabutoxide to PAA in methanol results in the rapid formation of a precipitate. In the final step, the substrate is heated at high temperatures (>450° C.) under atmospheric conditions to combust the polymer and remove organics. The modified polymer-assisted deposition process can then be utilized to deposit a second layer to increase the total metal oxide coating thickness. Hence, the total thickness is controlled by varying the number of PAD cycles.

The film thickness per cycle can be controlled by varying the molecular weight of the polymer. According to calculations for Ti-PAA systems, an average molecular weight of 2.5 kD would result in ˜0.7 nm TiO₂ per cycle, 25 kD would give 1.4 nm TiO₂ per cycle, 250 kD would give 3.0 nm TiO₂ per cycle, and 4000 kD would deposit 6.6 nm TiO₂ per cycle.

Variations in the polymer and metal oxide precursor chemistries can be customized in order to fine-tune the materials that are desired. For example, polycations can be deposited on top of surface-bound PAA and then utilized to electrostatically bind anionic complexes of Sr and Ti with controllable stoichiometry to ultimately form SrTiO₃ coatings. This process can be utilized for depositing nanoscale coatings of a variety of insulating, semiconducting, and conducting materials (e.g. SiO₂, Al₂O₃, ITO).

The polymer-assisted deposition techniques described above are also suitable for the deposition of conformal coatings of other high conduction band edge semiconductors like Nb₂O₅ and SrTiO₃.

Thermally-Activated Chemical Batch Deposition

For chemical bath deposition of metal oxide, a metal oxide precursor compound is typically heated under aqueous conditions and becomes hydrolytically unstable at a certain threshold temperature. Beyond this temperature, metal oxide deposition onto exposed surfaces occurs at an accelerated rate. For TiO₂ thin film deposition, an aqueous solution of titanium tetrachloride (TiCl₄ (aq)) is typically heated at 60-80° C. in order to thermally decompose the precursor compound and slowly deposit TiO₂ onto exposed surfaces.

This process has been used to increase interparticle necking between TiO₂ nanoparticles in TiO₂ nanoparticle-based DSSCs for the purpose of improving electron transport and overall device efficiencies. This process can be used to deposit metal oxide thin films onto 2-D substrates.

TiCl₄ (aq) solutions are highly acidic since adding TiCl₄ to water evolves HCl (g). Stoichiometrically, the proton concentration is necessarily four times that of the titanium concentration. The high acidity of the TiCl₄ (aq) solution can potentially dissolve the underlying material especially at elevated temperatures. Specifically, ITO nanoparticle dissolution can occur for TiCl₄ concentrations above 40 mM at temperatures exceeding 50° C.

In order to avoid ITO dissolution, the TiCl₄ (aq) concentration was lowered to be 10 mM. For lower TiCl₄ (aq) concentrations, the kinetics for deposition unfortunately become slow. Another way to avoid dissolution of ITO nanoparticles is to add sodium bicarbonate to TiCl₄ (aq) to decrease the acidity of the chemical bath; however, sodium hydroxide cannot be utilized since it is too reactive towards TiCl₄ (aq) and forms undesirable TiO₂ colloid. Another way to avoid dissolution of ITO nanoparticles is to add hydrogen peroxide to the TiCl₄ (aq) solution since H₂O₂ binds to the titanium metal center in a η² fashion (refs). Thermal activation of hydrogen peroxide/TiCl₄ (aq) solutions in the presence of a substrate deposits a peroxotitanium hydrate which is converted to anatase TiO₂ upon heating at elevated temperatures (>400° C.). Relative to TiCl₄ (aq) chemical bath deposition, TiCl₄/H₂O₂ (aq) chemical bath dissolution is more rapid and occurs at lower temperature.

Another method for avoiding dissolution of the underlying substrate in acidic environments involves the adsorption of surfactants to the surface. For example, a hydroxyl-terminated self-assembled monolayer (SAM) can be utilized that binds to the surface through a carboxylic acid group. However, aqueous environments such as TiCl₄ (aq) will cause complete desorption of the carboxylic acid groups from the surface. Superior stability towards water can be attained by using phosphonic acid head groups instead; however, the phosphorus atom will be difficult to jettison during the combustion step that is used to remove organic species. As an alternative, polyacrylic acid surfactant can be employed instead to improve the stability of the underlying material towards acid and to improve adhesion of the metal-oxide deposits to the surface of the underlying material. The molecular weight of PAA can be made small (e.g. MW<2000) in order to minimize the gap between metal oxide deposits and underlying substrate. Furthermore, the surface-bound PAA can react with TiCl₄ (aq) or TiCl₄/H₂O₂ (aq) and become infiltrated with TiO₂ precursor compounds and/or TiO₂. The infiltrated PAA polymer then becomes the foundation for subsequent TiO₂ layers deposited by chemical bath deposition.

The chemical bath deposition techniques described above are also suitable for the deposition of conformal coatings of other high conduction band edge semiconductors like Nb₂O₅ and SrTiO₃.

Layer-by-Layer Assembly

In a layer-by-layer (LbL) process, alternating anionic and cationic layers are deposited sequentially onto surfaces from aqueous solution. The anionic or cationic layers can be polyelectrolytes or charged complexes/molecules. In one embodiment of this invention, the cationic layer includes a polycationic polymer such as polyethylenimine (PEI) or polydiallyldimethylamine (PDDA) and the anionic layer includes an anionic metal oxide precursor compound (e.g. titanium (IV) bis(ammonium lactato)dihydroxide (TALH)). Layer-by-layer assembly requires that the underlying substrate be charged as well in order for the first layer to form. For metal-oxide materials, the pH must therefore be adjusted above or below the material's point of zero charge (PZE) to render the material negatively or positively charged, respectively.

This requirement is overcome by first adsorbing polyacrylic acid (PAA) to the surface of the underlying substrate material. Here, PAA acts as a polyanionic surfactant that binds tightly to the metal oxide surface. Typically, carboxylic acid groups are unstable in aqueous environments. However, the polycarboxylic nature of PAA allows for prudent exploitation of the chelate effect which disfavors desorption (i.e. displacement of all of the binding carboxylic acid groups is highly entropically unfavorable).

PAA binds effectively and quickly (within 10 minutes) to ITO nanoparticle films from pH=2 aqueous PAA solutions and methanolic solutions (typically 1 wt % is utilized). PAA becomes negatively charged above pH=4 and is neutral below pH=2. Adsorption of PAA to surface at pH=2 prevents complications caused by intermolecular electrostatic repulsion between surface-bound polymer strands, thereby minimizing pinholes in the PAA monolayer. PAA adsorption was verified by adsorbing a cationic dye molecule, Rhodamine B at pH=7. Adsorption of the dye was observed to be very rapid (<30 seconds). PAA contains carboxylic acid/carboxylate binding groups which are known to bind to a large variety of metal oxide surfaces (e.g. TiO₂, ZnO, Y₂O₃, SrTiO₃, Nb₂O₅, etc.). Hence, in one embodiment of this invention PAA can be broadly utilized as a base-layer for accomplishing layer-by-layer assembly.

Experiments demonstrated that the complex, titanium (IV) bis(ammonium lactato)dihydroxide, spontaneously decomposes to form TiO₂ in the presence of PEI or PDDA. This observation was exploited in LbL assembly consisting of alternating PEI/TALH or PDDA/TALH bilayers. It was also exploited by depositing PAA/PEI onto ITO nanoparticle thin films and then refluxing this film in the presence of 0.7 wt % aqueous TALH. This process selectively deposits TiO₂ layers on top of nanoITO/PAA/PEI. Thermal decomposition of the organic species PAA and PEI at 500° C. leaves behind the desired TiO₂ thin film.

A covalent, non-electrostatic layer-by-layer approach for depositing metal oxide materials onto pre-deposited nanoparticle thin films was invented. In this process, PAA was first bound to the ITO nanoparticles. The PAA/nanoITO film was then exposed to unstabilized ˜5 nm TiO₂ nanoparticles so that PAA's carboxylic acid groups can bind to TiO₂ nanoparticle surfaces. The PAA polymer was then either removed by combustion or the TiO₂/PAA/nanoITO film was then submerged again in PAA solution. Following these sequences allows for step-wise addition of TiO₂ nanoparticles onto the surface of the underlying material (in this case, ITO nanoparticle thin films). One problem with this strategy for conformal coatings is the inevitable presence of gaps between particles. This issue can be potentially overcome by using a follow-up coating method such as TiCl₄ (aq) treatment to fill-in the gaps to produce a conformal coating (see below, section E).

The LbL techniques described above are suitable for other materials, including high conduction band edge semiconductors like Nb₂O₅ and SrTiO₃.

Surface Sol Gel Process

The surface sol-gel process involves using a multi-step, cyclical process to slowly deposit metal-oxide films (˜0.5-1 nm per cycle). The steps involved include: 1) exposing the substrate to a reactive metal oxide precursor compound in organic solvent, 2) rinsing with organic solvent to remove unreacted precursor compound, 3) exposing the substrate to water to create metal-hydroxide species that can be used to deposit additional atomic-level layers. One issue with the surface sol-gel process is the adhesion of the metal-oxide material to the underlying nanoparticle material.

In order to improve the metal-oxide/substrate interaction, a hydroxyl-terminated self-assembled monolayer (SAM) can be utilized that binds to the surface through a carboxylic acid group. However, the integrity of this SAM will be sacrificed during step #3, since water will cause desorption of the carboxylic acid groups from the surface. Superior stability towards water can be attained by using phosphonic acid head groups instead; however, the phosphorus atom will be difficult to jettison during the combustion step that is used to remove the organic species. As an alternative, polyacrylic acid surfactant can be employed instead to improve the adhesion of the metal-oxide to the surface of the underlying material. The molecular weight of PAA can be made small (e.g. <2000) in order to minimize the gap between metal oxide deposits and underlying substrate. Furthermore, the surface-bound PAA can react with the metal oxide precursor and become infiltrated with metal oxide precursor compounds. The infiltrated PAA polymer then becomes the foundation for subsequent layers deposited by surface sol gel process.

In order to deposit 10-20 nm thick coatings of metal oxide materials with fewer cycles, more reactive chemistries can be tapped. For example, the nanoparticle film or nanostructure can be submerged into TiCl₄ dissolved in methylene chloride for a prescribed period of time, rinsed with a series of organic solvents (methylene chloride, methanol, and ethanol), and then submerged into deionized water to hydrolyze adsorbed titanium species.

In another method, the nanoparticle film can be submerged into an alcoholic solution containing a metal oxide precursor compound and stabilizer compound for a certain period of time (e.g. ethanolamine). The film is then removed and rinsed with alcohol to remove any titanium species that has not reacted with the surface. This process is then repeated to increase the thickness of the deposited coating. The coated nanoparticle film is then annealed at elevated temperature under atmospheric conditions to crystallize the coating (e.g. conversion of amorphous TiO₂ to anatase TiO₂). The thickness of the coating is controlled by varying the number of dip-coats and rinsing cycles.

The surface sol-gel techniques described above are suitable for other materials, including high conduction band edge semiconductors like Nb₂O₅ and SrTiO₃.

Electrodeposition of Metal Oxide Coatings onto 3-D Nanoparticle Films

A potential method for depositing metal oxide materials such as TiO₂ onto substrates is electrodeposition. This can be performed by electrochemically oxidizing a metal oxide precursor (e.g. TiCl₃ (aq)) to form hydrolytically unstable TiCl₄ which, in turn, results in the deposition of amorphous TiO₂ oligomers/polymers onto the semiconducting or conducting surface. Conversion of the amorphous deposits to crystalline material is carried out by thermally annealing the film under oxygen at elevated temperature (>400° C.). In the present invention, TiO₂ conformal coatings were deposited onto ITO nanoparticle thin films through electro-oxidation of TiCl₃ (aq). The thickness of the coating was controlled by varying the electrodeposition time.

Electrodeposition of metal oxide conformal coatings can also be realized by applying negative potentials large enough to reduce water to form hydroxide ions. The hydroxide ions that are produced then react and catalyze the hydrolysis of a metal oxide precursor compound; this reaction occurs locally adjacent to the electrode surface. As a result, deposition of the metal oxide occurs selectively onto the nearby surfaces to create a conformal metal oxide coating.

Moreover, other useful metal oxide coatings such as NiO and Co₃O₄ can also be produced through electrodeposition. With these coatings, the nanoparticle film is submerged into an aqueous electrolyte solution containing nickel or cobalt ions; a negative potential is then applied to the semiconducting or conducting nanoparticle film to electroreduce the ions to form a conformal metal coating on the surface. In a follow-up step, thermal annealing of the film at high temperature is performed in the presence of oxygen to convert the metal film to nickel oxide or cobalt oxide.

The Co₃O₄/conducting nanoparticle composite film can be utilized for electrocatalysis (e.g. water electrolysis). The NiO/conducting nanoparticle composite film can be utilized, for example, as a high surface area hole-conducting nanoparticle film in organic-based solar cells.

Other materials candidates and applications include the following: manganese oxide (electrocatalysis, photoelectrochemical cells, photocatalysis), iron oxide (electrocatalysis, spintronic devices, photoelectrochemical cells, photocatalysis), copper oxide (electrocatalysis, photoelectrochemical cells, photocatalysis), and chromium oxide (electrocatalysis, photoelectrochemical cells, photocatalysis).

Combining Coating Techniques

In order to eliminate pinholes in conformal coatings of metal oxides deposited onto an underlying nanoparticle thin film, two or more of the above coating or modified coating techniques can be combined To this end, polymer-assisted deposition, surface sol-gel, or thermally-activated chemical bath deposition can be combined, and combined with other deposition techniques.

The coating methods described above are suitable for the deposition of a wide variety of materials (insulators, semiconductors, conductors). Semiconductor materials suitable for this invention include for example Si, TiO₂, ZnO, Nb₂O₅, SnO₂, and SrTiO₃ and the other “semiconductive” materials described above, and NiO and other p-type materials. Use of these materials allows for the tuning of a semiconductor's conduction band edge energy over a 0.4 V range, thereby altering the driving force for the reductive process at the cathode.

While these materials can be deposited using the methods noted above, the present invention is not limited to those deposition processes and can utilize techniques known from the art such as thermal evaporation, ion sputtering, spin-coating, thermal oxidation of materials (e.g. Ti to TiO₂, Al to Al₂O₃), self-assembly, chemical bath deposition, electron beam evaporation, molecular beam epitaxy (MBE), pulsed laser deposition (PLD), and nanotransfer printing.

Moreover, using these techniques, all types of conducting nanostructures, including nanoparticle films, oriented nanotubes, oriented nanorods and nanowires, and nanofibers can be produced.

Fabrication of Conformally-Coated Composite Nanofiber Structures for Electron Transport Media in Solar Energy Conversion Devices

Other nanoarchitectures besides nanoparticle thin films can also potentially serve as electron or hole transport media in solar fuel devices. For instance, oriented nanowire arrays offer straight conduction pathways for charge carriers but are more difficult to manufacture than nanoparticle thin films and are potentially fragile especially at the long nanowire lengths that are required for complete absorption of incident light by chromophores. In contrast, polymer nanofibers offer an attractive, structural foundation for fabricating ETMs in light of their straightforward manufacturability. To this end, semiconductor-conductor composite ETM nanostructures can be fabricated in the following illustrative and not restrictive manner.

First, a solution containing polymer (e.g. polyvinylacetate, polyvinylpyridine, polyvinylpyrrolidinone) and transparent conducting oxide (TCO) precursor compounds is used to electrospin TCO-doped polymer nanofibers (diameters>100 nm) onto a planar transparent conducting oxide electrode (e.g. ITO or FTO, i.e. fluorine-doped tin oxide). For example, tin and indium oxide precursor compounds in the appropriate ratio (e.g. 90:10 In:Sn) are dissolved in solvent along with an electrospinnable polymer. The resulting TCO-doped polymer nanofibers are then annealed at high temperature to burn away the polymer, leaving behind TCO nanofibers electrode.

A conformal coating method is then implemented to deposit a conformal layer of semiconducting material onto the TCO nanofibers, affording coaxial semiconductor-conductor nanofibers.

### Semiconductor-Conductor Hybrid Nanoparticle Electrodes

A solar fuel device requires three components: (1) a light-harvesting chromophore that absorbs sunlight to produce an initial charge-separated state consisting of an oxidized chromophore and a reduced electron acceptor (e.g. typically a semiconductor such as Ti0₂, (2) an electron transport medium (ETM) that further separates the electrons and holes by selectively carrying the electrons to a catalyst for proton reduction, and (3) an electrocatalyst that uses the holes to oxidize water to produce protons and oxygen.

FIG. 3A is a fabrication process schematic showing the preparation of hybrid semiconductor-conductor porous nanoparticle structures according to one embodiment of this invention. As shown in FIG. 3A, the gray spheres represent conducting nanoparticles; the blue coatings represent a conformal semiconducting coating on the nanoparticles; the red box=represents a chromophore; the blue box represents a water oxidation catalyst. FIG. 3B is a fabrication process schematic showing preparation of hybrid semiconductor-conductor nanorod array electrodes. As shown in FIG. 3B, the gray spheres represent conducting nanoparticles, and the blue outline represents conformal semiconducting coatings.

Accordingly, in one embodiment, the inventive structure includes on a first electrode a stacked array of conducting nanoparticles having conformally coated porous semiconductor layers encasing abridging conducting nanoparticles. Electrons or holes generated from absorption of solar energy in the chromophore are injected into the stacked array of conducting nanoparticles and from there are conducted to the first electrode to establish a voltage potential with respect to a second electrode acting as a reduction site electrode. Such electrodes can serve as photocathodes, photoanodes, and/or tandem cell electrodes employing both photocathodes and photoanodes.

Thus, in one embodiment of this invention, there is provided a semiconductor shell nanostructure formed over one or more conductive cores in which electrons or holes only have to be transported over nanoscale lengths before reaching a conductor. By making the electron diffusion length vanishingly small, electron-hole recombination rates substantially decrease allowing for a sufficient supply of electrons to drive a four electron oxidation of water into protons and oxygen in a region in vicinity of the stacked array of conducting nanoparticles. Electrons at the second electrode can be used to reduce protons to hydrogen or for example to reduce carbon dioxide to methanol, methane, or hydrocarbons. Likewise, by making the hole diffusion length vanishingly small, electron-hole recombination rates substantially decrease allowing for a sufficient supply of electrons to drive a two electron reduction of water into hydrogen. Holes at the second electrode can be used to oxidize water into protons and oxygen.

### Fabrication and Characterization of Hybrid Semiconductor-Conductor Nanorod Array Electrodes

Conductive nanorod arrays are prepared by placing a track-etched, hydrophilic polycarbonate membrane on top of a planar TCO electrode. Electrophoresis is then used to deposit conductive ITO nanoparticles from a colloidal suspension into the porous membrane to produce high aspect ratio, template-directed conductive nanorods (see FIG. 3B). The diameter of the nanorod will depend on the pore size of the commercially available membranes (typically 50, 100, or 200 nm), and the length will depend on the colloid concentration and the time of deposition. The membrane is then burned off with a 500° C. annealing step. The annealing step also minimize the resistance of the nanorods.

After the membrane is burned off, the same five methods for depositing the semiconductor listed above can be used to form a conformal semiconductor coating. Plasma-enhanced CVD and ALD would be likely to achieve a conformal coating of the semiconductor due to the higher porosity of the electrode, and thus would be preferred. Another preferred deposition method suitable for this type of nanostructured electrode is the electrophoretic deposition of semiconductor nanoparticles onto the conductive nanopillars to produce a conformal coat.

Using the techniques described above, ITO nanoparticle electrodes can be routinely fabricated by spin-coating a nanoITO colloidal suspension onto a transparent planar ITO/glass. Working examples prepared were 2.5 cm by 2.5 cm nanoITO/planar ITO/glass electrodes. However, larger substrate sizes are manufacturable with scaled deposition equipment.

In the working examples, the thickness of the film was controlled with the spin rate and the concentration of the ITO nanoparticles in the suspension. After spin coating, the ITO nanoparticles films were annealed under atmospheric conditions to improve interconnectivity between particles and decrease film resistance. Both 20 nm and 40 nm nanoITO suspensions have been prepared and utilized for depositing 20 and 40 nm nanoITO thin films. For 40 nm particles, the film thickness was either ˜800 nm (15 wt % colloidal suspension) or ˜3 microns (30 wt % colloidal suspension), as determined by profilometry. Film thicknesses have also been verified using cross-sectional SEM. Films consisting of either 20 or 40 nm ITO nanoparticles are conductive (<80 ohm) as verified by two-point probe measurements. Cyclic voltammetry (CV) experiments also suggest that the films are conductive and have high surface areas.

A redox-active Ruthenium compound was adsorbed to the surface of the nanoITO film and the Ruthenium-functionalized nanoITO/planar ITO/glass film was used as a working electrode in a three electrode cell. FIG. 4 is a plot of the cyclic voltammetry results for 40 nm ITO nanoparticle films derivatized with a redox-active ruthenium compound. In the CV plot, positive current is oxidative, and negative current is reductive. The high currents (˜1 mA) for the oxidation and reduction waves demonstrate that the surface-bound Ruthenium complexes are electrochemically addressable and that Ru compounds throughout the entire thickness of the film can undergo redox reactions. The fact that the currents for the oxidation and reduction waves are approximately the same indicates that the process is reversible.

FIG. 5A is a table comparing incident photon-to-current efficiency (IPCE) and absorbed photon-to-current efficiency (APCE) data for dye-sensitized solar cells constructed using the TiO₂/ITO nanocomposite structures of this invention. Compared with normal nanoTiO₂ photoelectrodes; the APCE data shows that in some instances the coating method gives APCEs that are on par with the composite structure and a conventional TiO₂ electrode.

FIG. 5B incident photon-to-current efficiency data for dye-sensitized solar cells constructed using a TiO₂/ITO nanocomposite structures and a Nb₂O₅/ITO nanocomposite structure. The IPCE for the Nb₂O₅/ITO composite is on par with that for normal dye-sensitized Nb₂O₅ nanoparticle films. In one aspect of this invention, the core-shell approach permits relatively poor performing metal oxide semiconducting materials such as SrTiO₃, Nb₂O₅, Ta₂O₅, and NiO to be used without having to overcome the limitations of these materials presented by their high defect densities and other intrinsic disadvantages.

FIG. 6 is a schematic of an organic photovoltaic device incorporating nanocomposite semiconductor/conductor nanoparticle structures. The conjugated polymer and electron/hole acceptor blend are introduced into the pores of the composite structure, forming a bicontinuous system. The electron/hole transport distance between organic conjugated polymer and the composite structure is greatly reduced with these structures and the core-shell approach is expected to hinder charge recombination while favoring charge collection and transport.

The morphology of the nanoITO films was explored by atomic force microscopy (AFM). The AFM data shows that the films are porous and include nanoparticles indicating potentially high surface area. The pores allow for diffusion of small molecules into and out of the film and will be an extremely important aspect for solar fuel devices. Scanning electron microscopy also shows preservation of the porous structure after the coating was applied (i.e., the pores are not consolidated by the coating process).

FIG. 7 is a micrograph of a transmission electron microscopy image of the 40 nm ITO nanoparticles after thin film annealing. Transmission electron microscopy images were also taken for 20 and 40 nm ITO nanoparticles after film formation and annealing (FIG. 7). This data shows the interparticle connectivity, particle size, and size distribution.

P-Type Composite Nanostructures

As noted above, a photoelectrochemical solar fuel device can be a two electrode cell which converts light energy into chemical energy in the form of high energy fuels. Light absorption and initial charge separation can occur at either a photoanode containing n-type semiconducting material or a photocathode containing p-type semiconducting material. For a solar fuel cell having a photocathode, the electrons or reducing equivalents are passed to nearby catalysts which allow for the reduction of protons to evolve hydrogen or carbon dioxide to form various products (e.g. CO, methanol, methane). The holes are collected from the photocathode and passed via an external circuit to catalysts at the anode, where they can potentially oxidize water.

In one embodiment of the invention, p-type semiconductor-conductor composite nanostructures are provided for example using NiO nanoparticles and doped metal oxides/sulfides. Conventional p-type semiconductor NiO nanoparticle-based photocathodes have shown limited performance in dye-sensitized solar cells for photovoltaic applications. The semiconductor-conductor composite structures of this invention would lead to improved p-type device efficiencies.

The performance of bulk heterojunction organic photovoltaic devices has been limited by hole transport through the organic semiconducting polymer. The use of p-type semiconductor coated-conducting nanostructures should minimize hole transport lengths and improve hole collection efficiencies. As a result, thicker bulk heterojunctions can be utilized, thereby significantly improving light harvesting, leading to higher efficiency devices.

The techniques for producing a p-type semiconductor-conductor composite nanostructure follow those described above except the choice of semiconductor material. As noted above, all types of conducting nanostructures, including nanoparticle films, oriented nanotubes, oriented nanorods and nanowires, and nanofibers can be produced from these techniques.

The conductive material in this embodiment includes, but is not limited to, one of the following conducting oxides (TCO): tin-doped indium oxide (ITO), antimony-doped tin oxide (ATO), fluorine-doped tin oxide (FTO), aluminum-doped zinc oxide (AZO), gallium-doped zinc oxide (GZO), and indium-doped zinc oxide (IZO). For nanoparticle thin films, the conductive nanoparticles can be deposited, for example, by spin coating, doctor-blade methods, or spray coating techniques described above. The particle size of the conductive nanoparticles can be chosen to control surface area as well as the average diameter of the pores and pore volume. For nanofibers, the conductive material can be deposited by co-electrospinning a solution of polymer and precursor compounds; the polymer template can then be combusted away with a post-annealing process.

A conformal coating of p-type semiconductor is then applied using one of the methods described above.

The thickness of the conformal coating can be in the range 0.5 nm-100 nm. A schematic of a p-type semiconductor coated nanostructure is depicted in FIG. 8. FIG. 8 is a schematic of a photocathode having a conducting nanostructure coated with a p-type semiconductor. In this embodiment, both chromophores and catalysts are adsorbed to the surface of the nanostructure to allow for conversion of sunlight to fuels. In this example, CO₂ reduction products (CO, methanol, methane) would be produced.

As noted above, suitable p-type semiconducting materials include NiO, delafossites, Cu2O, p-SiC, and doped metal oxides/sulfides. For solar cell applications, it is desirable for the p-type semiconductor to be as transparent as possible over the visible-near IR range. Semiconductor-conductor composite structures are advantageous in this regard because the majority of the nanostructure consists of the transparent conducting oxide material with only a relatively thin layer of the p-type semiconductor deposited on top. As before, annealing is used to consolidate the electrode materials prior to conformal deposition of the semiconductor material.

In this embodiment, conductive nanorod arrays for solar energy conversion devices can be prepared by first placing a porous template with aligned channels (e.g. commercially-available anodic alumina templates, track-etched hydrophilic polycarbonate membranes) on top of a planar TCO substrate (e.g. ITO, FTO). Similar to the techniques described above, the template/TCO substrate is then submerged into an aqueous or non-aqueous suspension of conductive nanoparticles and electrophoresis is then used to deposit the conductive nanoparticles from a colloidal suspension into the porous membrane to produce high aspect ratio, template-directed conductive nanorods consisting of the elementary nanoparticles.

As noted above, the diameter of the nanorod will depend on the pore size of the porous template (typically 50, 100, or 200 nm), and the length will depend on the conductive nanoparticle concentration and/or the time of deposition.

Following electrophoretic deposition, the porous template is removed to leave behind the oriented nanorod/nanowire structures. For example, track-etched polycarbonate membranes can be removed easily by burning it off during a high-temperature post-annealing process. The annealing step will also sinter together the nanoparticles within the nanorod structure and minimize the resistance along the length of the nanorod. Anodic alumina templates can be removed by selectively etching away the alumina through chemical means.

After the template is removed, the conformal coating methods listed above are used to form a layer of semiconductor on top of the nanostructure. After annealing of the semiconductor, these electrodes are ready for use in a solar energy conversion device (solar fuels, photovoltaics).

Alternative Structures

One alternative structure involves the deposition of water oxidation catalysts like Co₃O₄ onto the conducting framework for applications in PV-water electrolyzer systems and photocatalysis. Similarly, electrodeposition or other methods can be used to deposit hole-conducting metal oxides like NiO onto high surface area conductive films offers another way to improve hole transport and the efficiency of low-cost organic-based PVs. Finally, alternate conducting materials for the nanostructured electrodes such as aluminum-doped zinc oxide and metal nanoparticles (e.g. Au) can be used.

### Alternative Applications

In one application, the core-shell structures are used to improve the quantum yield of photocatalysis for the degradation of organic and inorganic contaminants. These films can also be used in self-cleaning applications. This application constitutes an improvement over the typical gold standard for photocatalysis, i.e. TiO₂ coatings, nanoparticles, dispersions, and thin films. In other applications, the core-shell structures serve as high surface area catalytic electrodes in fuel cells and electrolyzers. In another application, the core-shell structure serves as a high surface area charge storage electrode for battery applications (e.g. LiFePO4/conductor, NiO/conductor). In another application, the core-shell structure serves as hole-transfer electrode or electron-transfer electrode in light-emitting diodes. In another application, the core-shell structure serves as a high surface area electrode in an ultracapacitor (e.g. insulator/conductor core-shell structure).

Generalized Aspects of the Invention

The following numbered statements reflect various generalized aspects of this invention.

Statement 1. An electrode for solar conversion, comprising:

a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor, the porous structure including,

a set of electrically conductive nanoparticles adjoining each other,

said set of electrically conductive nanoparticles forming a meandering electrical path connecting the nanoparticles together, and

a semiconductive coating having a thickness less than 10 microns and disposed conformally on the electrically conductive nanoparticles to form an exterior surface for reception of charge carriers.

Statement 2. The electrode of statement 1, wherein the semiconductive coating has a thickness less than 500 nm.

Statement 3. The electrode of statement 1, wherein the semiconductive coating has a thickness less than 100 nm.

Statement 4. The electrode of statement 1, wherein the semiconductive coating has a thickness less than 10 nm.

Statement 5. The electrode of statement 1, wherein the semiconductive coating has a thickness between 1 nm and 10 nm.

Statement 6. The electrode of statement 1, wherein the semiconductive coating comprises a material which absorbs solar radiation.

Statement 7. The electrode of statement 1, wherein the semiconductive coating comprises at least one of Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh), and perovskite structures of the form ABX₃.

Statement 8. The electrode of statement 1, wherein the semiconductive coating comprises at least one of a p-type and n-type material.

Statement 9. The electrode of statement 1, wherein said chromophore comprises at least one of a monomer, an oligomers and a polymer.

Statement 10. The electrode of statement 9, wherein said chromophore comprises at least one of a porphyrin, a pyrene, a perylene, a xanthene, a phthalocyanine, a coumarin, a rhodamine, a buckminsterfullerene, a thiophene, a transition metal polypyridyl complex, a ferrocene, a methyl viologen, a donor-acceptor dye, and combinations thereof.

Statement 11. The electrode of statement 1, wherein the catalyst is at least one of attached to the chromophore, attached to the semiconductive coating, in solution in the porous structure, or located remotely with respect to the porous structure.

Statement 12. The electrode of statement 1, wherein the catalyst comprises at least one of iridium, iron, cobalt, ruthenium, osmium, nickel, manganese, platinum, palladium, a transition metal, a transition metal oxide, or a transition metal complex.

Statement 13. The electrode of statement 1, wherein the exterior surface for reception of charge carriers comprises a surface area in a range between 5 and 400 m²/gm.

Statement 14. The electrode of statement 1, wherein the electrically conductive nanoparticles comprise at least one of zinc-doped tin oxide, tin-doped indium oxide, fluorine-doped tin oxide, antimony tin oxide, gallium zinc oxide, indium zinc oxide, copper aluminum oxide, fluorine-doped zinc oxide, magnesium-doped copper chromium oxide, Sr₂Cu₂O₂, a doped delafossite conducting oxide material based on CuMO₂ (where M=Al, Ga, Cr, Fe, In, Y, B, Sc, Mn, Co, Rh), graphene, carbon, aluminum zinc oxide, organic dyes, aromatic compounds, organic conducting polymers, polymers with conjugated bonds, and charge-transfer molecular complexes.

Statement 15. The electrode of statement 1, wherein the electrically conductive nanoparticles have an average diameter ranging from 10 to 1000 nm.

Statement 16. The electrode of statement 1, wherein the electrically conductive nanoparticles have an average diameter ranging from 50 to 200 nm.

Statement 17. The electrode of statement 1, wherein the electrically conductive nanoparticles have an average diameter ranging from 20-80 nm.

Statement 18. The electrode of statement 1, wherein the porous structure has a porosity ranging from 50 to 90%.

Statement 19. The electrode of statement 1, wherein the porous structure comprises a coating on a base of the electrode.

Statement 20. The electrode of statement 1, wherein the porous structure comprises at least one stack extending vertically from a base of the electrode.

Statement 21. The electrode of statement 1, wherein the semiconductive coating comprises a barrier separating charge carriers in the set of electrically conductive nanoparticles from recombining with charge carriers on the surface of the porous structure or within the porous structure.

Statement 22. The electrode of statement 1, further comprising a barrier layer coating on the semiconductive coating.

Statement 23. The electrode of statement 21, wherein the barrier layer comprises at least one alumina, tin oxide, zirconium oxide, silicon oxide, and magnesium oxide.

Statement 24. The electrode of statement 21, wherein the semiconductive layer and the barrier layer comprise a multilayered structure having layers of the semiconductive layer and the barrier layer.

Statement 25. The electrode of statement 24, wherein the multilayered structure comprises SnO₂/TiO₂, SnO₂/TiO₂/Al₂O₃, SnO₂/ZnO/TiO₂, SnO₂/ZnO/TiO₂/Al₂O₃, ZnO/TiO₂, ZnO/TiO₂/Al₂O₃, NiO/Al₂O₃.

Statement 26. The electrode of statement 21, wherein the barrier layer has a thickness no greater than 10 nm.

Statement 27. The electrode of statement 21, wherein the semiconductive layer comprises a multilayered structure having multiple semiconductor layers.

Statement 28. A solar conversion device comprising:

an anode and a cathode at least one which comprises the electrode of any one of statements 1-27 and includes said porous structure;

at least one of the anode and the cathode comprising a photoelectrode.

Statement 29. The solar conversion device of statement 28, wherein at least one of the anode and the cathode comprises a transparent electrode.

Statement 30. The solar conversion device of statement 28, further comprising:

a feedstock supply configured to supply feedstock into a region between the anode and cathode;

the anode configured to oxidize the feedstock; and

the cathode configured to reduce constituents of the feedstock into a combustible fuel.

Statement 31. The solar conversion device of statement 28, wherein

said chromophore of statement 1 is attached to the photoelectrode for absorption of solar light and injection of charge carriers into the porous structure.

Statement 32. The device of statement 28, wherein said chromophore, redox couple, and electron/hole-conducting polymer of statement 1 are disposed within the anode and cathode and comprise a dye-sensitized solar cell.

Statement 33. The device of statement 32, wherein

the chromophore is on the exterior surface of the semiconductive coating, and

at least one of the redox couple electrolyte or the electron/hole conducting polymer is disposed inside pores of the porous structure.

Statement 34. The device of statement 28 wherein said organic conducting polymer and electron/hole accepting material of statement 1 are disposed within the anode and cathode and comprise an organic photovoltaic device.

Statement 35. The device of statement 34, wherein the polymer and the electron/hole accepting material are disposed inside pores of the porous structure.

Statement 36. The device of statement 35, wherein a blend of the polymer and the electron/hole accepting material are disposed inside pores of the porous structure.

Statement 37. A solar conversion device comprising:

a first electrode including the electrode of any one of statements 1-27.

Statement 38. The device of statement 37, further comprising a second electrode having a non-porous structure.

Statement 39. A photocatalytic device comprising the electrode of any one of statements 1-27, wherein the core-shell nanostructure is irradiated with light and degrades organic and inorganic contaminants.

Numerous modifications and variations of the present invention are possible in light of the above teachings. It is therefore to be understood that within the scope of the appended claims, the invention may be practiced otherwise than as specifically described herein.

1. An electrode for solar conversion, comprising:
a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor, the porous structure including,
a set of electrically conductive nanoparticles adjoining each other,
said set of electrically conductive nanoparticles forming a meandering electrical path connecting the nanoparticles together, and
a semiconductive coating having a thickness less than 10 microns and disposed conformally on the electrically conductive nanoparticles to form an exterior surface for reception of charge carriers.

2. The electrode of claim 1, wherein the semiconductive coating has a thickness less than 500 nm.

3. The electrode of claim 1, wherein the semiconductive coating has a thickness less than 100 nm.

4. The electrode of claim 1, wherein the semiconductive coating has a thickness less than 10 nm.

5. The electrode of claim 1, wherein the semiconductive coating has a thickness between 1 nm and 10 nm.

6. The electrode of claim 1, wherein the semiconductive coating comprises a material which absorbs solar radiation.

7. The electrode of claim 1, wherein the semiconductive coating comprises at least one of Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh), and perovskite structures of the form ABX₃.

8. The electrode of claim 1, wherein the semiconductive coating comprises at least one of a p-type and n-type material.

9. The electrode of claim 1, wherein said chromophore comprises at least one of a monomer, an oligomers and a polymer.

10. The electrode of claim 9, wherein said chromophore comprises at least one of a porphyrin, a pyrene, a perylene, a xanthene, a phthalocyanine, a coumarin, a rhodamine, a buckminsterfullerene, a thiophene, a transition metal polypyridyl complex, a ferrocene, a methyl viologen, a donor-acceptor dye, and combinations thereof.

11. The electrode of claim 1, wherein the catalyst is at least one of attached to the chromophore, attached to the semiconductive coating, in solution in the porous structure, or located remotely with respect to the porous structure.

12. The electrode of claim 1, wherein the catalyst comprises at least one of iridium, iron, cobalt, ruthenium, osmium, nickel, manganese, platinum, palladium, a transition metal, a transition metal oxide, or a transition metal complex.

13. The electrode of claim 1, wherein the exterior surface for reception of charge carriers comprises a surface area in a range between 5 and 400 m²/gm.

14. The electrode of claim 1, wherein the electrically conductive nanoparticles comprise at least one of zinc-doped tin oxide, tin-doped indium oxide, fluorine-doped tin oxide, antimony tin oxide, gallium zinc oxide, indium zinc oxide, copper aluminum oxide, fluorine-doped zinc oxide, magnesium-doped copper chromium oxide, Sr₂Cu₂O₂, a doped delafossite conducting oxide material based on CuMO₂ (where M=Al, Ga, Cr, Fe, In, Y, B, Sc, Mn, Co, Rh), graphene, carbon, aluminum zinc oxide, organic dyes, aromatic compounds, organic conducting polymers, polymers with conjugated bonds, and charge-transfer molecular complexes.

15. The electrode of claim 1, wherein the electrically conductive nanoparticles have an average diameter ranging from 10 to 1000 nm.

16. The electrode of claim 1, wherein the electrically conductive nanoparticles have an average diameter ranging from 50 to 200 nm.

17. The electrode of claim 1, wherein the electrically conductive nanoparticles have an average diameter ranging from 20-80 nm.

18. The electrode of claim 1, wherein the porous structure has a porosity ranging from 50 to 90%.

19. The electrode of claim 1, wherein the porous structure comprises a coating on a base of the electrode.

20. The electrode of claim 1, wherein the porous structure comprises at least one stack extending vertically from a base of the electrode.

21. The electrode of claim 1, wherein the semiconductive coating comprises a barrier separating charge carriers in the set of electrically conductive nanoparticles from recombining with charge carriers on the surface of the porous structure or within the porous structure.

22. The electrode of claim 1, further comprising a barrier layer coating on the semiconductive coating.

23. The electrode of claim 21, wherein the barrier layer comprises at least one alumina, tin oxide, zirconium oxide, silicon oxide, and magnesium oxide.

24. The electrode of claim 21, wherein the semiconductive layer and the barrier layer comprise a multilayered structure having layers of the semiconductive layer and the barrier layer.

25. The electrode of claim 24, wherein the multilayered structure comprises SnO₂/TiO₂, SnO₂/TiO₂/Al₂O₃, SnO₂/ZnO/TiO₂, SnO₂/ZnO/TiO₂/Al₂O₃, ZnO/TiO₂, ZnO/TiO₂/Al₂O₃, NiO/Al₂O₃.

26. The electrode of claim 21, wherein the barrier layer has a thickness no greater than 10 nm.

27. The electrode of claim 21, wherein the semiconductive layer comprises a multilayered structure having multiple semiconductor layers.

28. A solar conversion device comprising:
an anode and a cathode at least one of which comprises;
an electrode having,
a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor, the porous structure including,
a set of electrically conductive nanoparticles adjoining each other,
said set of electrically conductive nanoparticles forming a meandering electrical path connecting the nanoparticles together,
a semiconductive coating having a thickness less than 10 microns and disposed conformally on the electrically conductive nanoparticles to form an exterior surface for reception of charge carriers; and
at least one of the anode and the cathode comprising a photoelectrode.

29. The solar conversion device of claim 28, wherein at least one of the anode and the cathode comprises a transparent electrode.

30. The solar conversion device of claim 28, further comprising:
a feedstock supply configured to supply feedstock into a region between the anode and cathode;
the anode configured to oxidize the feedstock; and
the cathode configured to reduce constituents of the feedstock into a combustible fuel.

31. The solar conversion device of claim 28, wherein
said chromophore is attached to the photoelectrode for absorption of solar light and injection of charge carriers into the porous structure.

32. The device of claim 28, wherein said chromophore, redox couple, and electron/hole-conducting polymer are disposed within the anode and cathode and comprise a dye-sensitized solar cell.

33. The device of claim 32, wherein
the chromophore is on the exterior surface of the semiconductive coating, and
at least one of the redox couple electrolyte or the electron/hole conducting polymer is disposed inside pores of the porous structure.

34. The device of claim 28 wherein said organic conducting polymer and electron/hole accepting material are disposed within the anode and cathode and comprise an organic photovoltaic device.

35. The device of claim 34, wherein the polymer and the electron/hole accepting material are disposed inside pores of the porous structure.

36. The device of claim 35, wherein a blend of the polymer and the electron/hole accepting material are disposed inside pores of the porous structure.

37. The device of claim 37, further comprising a second electrode having a non-porous structure.

38. A photocatalytic device comprising an electrode having,
a porous structure configured to contain therein at least one of an electrolyte, a catalyst, a chromophore, a redox couple, a hole-conducting polymer, an electron-conducting polymer, a semiconducting organic conjugated polymer, an electron acceptor, and a hole acceptor, the porous structure including,
a set of electrically conductive nanoparticles adjoining each other,
said set of electrically conductive nanoparticles forming a meandering electrical path connecting the nanoparticles together,
a semiconductive coating having a thickness less than 10 microns and disposed conformally on the electrically conductive nanoparticles to form an exterior surface for reception of charge carriers; and
wherein the core-shell nanostructure is irradiated with light and degrades organic and inorganic contaminants.
